(19) United States
(12) Patent Application Publication
(10) Pub. No.: US 2010/0194191 A1
(43) Pub. Date: Aug. 5, 2010

(54) Device for Operating an Electrical User on a Motor Vehicle

(76) Inventors: Dieter Brozio, Essen (DE); Berthold Sieg, Bottrop (DE)

Correspondence Address: QUARLES & BRADY LLP, 411 E. WISCONSIN AVENUE, SUITE 2040, MILWAUKEE, WI, 53202-4497, US

(21) Appl. No.: 12/594,538

(22) PCT Filed: Apr. 1, 2008
(86) PCT No.: PCT/DE2008/000552

§ 371 Date: Mar. 22, 2010

(30) Foreign Application Priority Data
Apr. 5, 2007 (DE) 20 2007 005 077.1

(51) Int. Cl. B60L 1/00

(52) U.S. Cl. 307/9.1

(57) ABSTRACT

The invention relates to a device (1), for operating an electrical user (10), in particular an electric motor on a motor vehicle (2). The device (1) comprises an electrical controller (4), which can be connected to an earth voltage (15), at least one electrical user (10), at least one electrical line (8, 12), connecting the user(s) (10) to the electronic controller (4) and at least one earth connection (14), connecting the electrical user(s) (10) to the earth voltage (15) via the controller (4). Said device can be used to operate for example, hatches, sliding doors and doors with electric motors.

The present invention relates to an apparatus for the operation of an electrical load, particularly an electric motor, in a motor vehicle. The apparatus can be used to move flaps, sliding doors and doors, for example, by electric motors.

The development of electronic assemblies shows that information is being processed with ever lower power levels, that the functionality for said electronic assemblies is continually increasing and that at the same time the size thereof is constantly decreasing. However, this development also results in the operation of electronic assemblies being able to be disrupted more easily by electromagnetic radiated interference. To ensure a sufficient level of reliability and the operation of such assemblies, electromagnetic compatibility (EMC) plays an important part. Improved electromagnetic compatibility of components can be achieved, by way of example, by reducing the power of radiated interference and/or improving the shielding of sensitive electronic assemblies against electromagnetic interference.

If an electronic assembly is connected to an electrical load by means of electrical lines, electromagnetic interference originating from the electronic assembly can reach the electrical load via the lines. The electrical load and the electrical lines can then act as an antenna and emit the electromagnetic interference into the environment. If the electrical load is also connected to a door or a flap on a motor vehicle, for example, it is also possible for these parts of the motor vehicle to favor the emission of the electromagnetic interference.

An electronic component on its own will emit only very little interference when suitable shielding is used. If an electronic component is connected to an electrical load by means of electrical conductors, however, electromagnetic interference emissions from the electronic component cause interference voltages, particularly high-frequency common-mode interference voltages, and/or interference currents, particularly high-frequency common-mode interference currents, in the supply lines for the electrical load. The electrical load, the supply lines and the metal elements to which the load is connected can then act as an antenna and emit the electromagnetic interference to the environment. The intensity of this effect is also dependent on the frequency of the interference voltages.

Against this background, it is an object of the present invention to specify an apparatus which at least partially solves the problems outlined with reference to the prior art, the aim being particularly to specify an apparatus which connects an electronic assembly to an electrical load by means of electrical lines such that no or very little radiated interference occurs. In addition, the apparatus is intended to be inexpensive and flexibly positionable in the vehicle and to provide the option of subsequently improving existing systems (retrofitting).

These objects are achieved by means of an apparatus in accordance with the features of the independent claims. Further advantageous refinements are specified in the respective dependent claims. It should be pointed out that the features presented individually in the patent claims can be combined with one another in any manner which makes technological sense, and exhibit further refinements of the invention. The description, particularly in conjunction with the figures, provides advice of further preferred refinements of the invention.

Therefore, the inventive apparatus for the operation of at least one electrical load in a motor vehicle comprises at least:
one electronic control unit which can be connected to a ground potential,
at least one electrical load,
at least one electrical line which connects the at least one electrical load to the electronic control unit,
at least one ground connection which connects the at least one electrical load to the ground potential via the electronic control unit.

Examples of suitable electrical loads are an electrical drive or an electrical switch, a radio, a loudspeaker box, an antenna or a similar electrical load in a motor vehicle which is connected by means of electrical lines to an electronic assembly, particularly a controller and/or regulatory unit. The connection of the electrical load to a ground connection by means of the control unit for the ground potential serves to avoid and/or reduce electromagnetic radiated interference. If the electronic assembly emits electromagnetic interference, said interference can cause an interference current, particularly a high-frequency common-mode current, in the supply lines for the electrical load. These interference currents can then be emitted by the load in the form of electromagnetic radiated interference. A connection between the electrical load and the ground potential discharges the interference currents to ground potential and can thus reduce the radiated interference.

Ground potential particularly means an electrical potential in an article. In the case of a motor vehicle, the bodywork may be an article at ground potential, for example. The electrical connection of an article at ground potential to another component, particularly a control unit, or an electrical load is made by means of a ground connection which electrically conductively connects the component to a ground potential or to an article which is at ground potential.

The electrical lines can be used to supply an electrical load with electrical power, for example, and/or also to transmit electrical signals. If the electrical load is an electric motor, the electric motor can be provided with a supply voltage via an electronic control unit, particularly an electronic controller. The electric motor can be actuated by the electrical control unit particularly using pulse width modulation (PWM).

Usually, the electrical lines (or at least one of them) and the ground connection are produced with a different cross section, the ground connection regularly having a larger cross section—but this is not absolutely necessary.

In line with one development of the invention, an apparatus is proposed, wherein the at least one electrical load comprises at least one electric motor, wherein also the at least one electric motor preferably has a housing and at least two electrical terminals, in which a respective electrical line is connected to an electrical terminal and the, particularly one, ground connection is connected to the housing.

The interference currents flowing in the electrical lines can reach the housing and be emitted therefrom by means of capacitive coupling. The electromagnetic interference radiated from the housing is now reduced by connecting the housing of the motor, particularly the metal or electrically conductive parts of the housing, to the electronic control unit by means of the ground connection, and said control unit being connected to the ground potential.

The position of the electrical lines relative to the ground connection has an effect on the magnitude of the radiated interference which occurs. Positions for the lines with respect to the ground connection which have low radiated interference are described in the subsequent developments of the invention.

In line with one development of the invention, the at least one electrical line and the at least one ground connection, which determine a connection path, are in contact with one another for the majority of the connection path, the majority preferably being at least 70% or even at least 90% of the connection path.

In this case, the connection path means the path from the electrical load via a ground connection or via an electrical line to the electronic control unit. The contact between the ground connection and an electrical line also covers the electrical line being no further than 5 cm (or even just 2 cm and possibly no more than 0.8 cm), for example, away from the ground connection (or these being in direct contact with one another). The contact between the electrical lines and the ground connection can also be achieved by virtue of the electrical lines being bonded to the ground connection, or having a shared sleeve and in this way forming a cable which encloses the electrical lines and the ground connection. In this case, the electrical lines and the ground connection are electrically insulated from one another. This has the advantage that during installation in the motor vehicle only one cable needs to be laid and the electrical lines are already in a suitable position relative to the ground connection.

In line with a further development of the invention, an apparatus is proposed in which the at least one electrical line is not intertwined with the at least one ground connection. Not intertwined also means that the electrical line is not twisted with the at least one ground connection or that the electrical line does not twine around the ground connection, which is frequently the thicker connection in comparison with the electrical line. Such intertwining can have a disadvantageous effect on the power of the radiated interference arising from the apparatus.

In line with a further development of the invention, an apparatus is proposed in which a plurality of electrical lines are provided, wherein a ground connection is positioned centrally with respect to the plurality of electrical lines. Such positioning is distinguished by particularly low radiated interference powers from the apparatus.

With three electrical lines and one ground connection, the central position can mean, for example, that the ground connection between the first and second or between the second and third lines is arranged in one plane, or that the lines are situated along an imaginary hollow cylinder which surrounds the ground connection.

In line with one development of the invention, an apparatus is proposed in which two electrical lines are arranged in one plane and a single ground connection is positioned in between. In other words, this also means that two electrical lines are situated externally and a ground connection is positioned in between in contact with both lines, possibly in the manner of what is known as a ribbon. Such an arrangement allows simple laying of the lines in the vehicle with simultaneously minimized radiated interference powers from the apparatus.

In addition, the invention proposes using the apparatus for moving a flap on a motor vehicle. The flap may be, in particular, a door, a sliding door, a sliding roof, a tailgate, a window, the hood, the gas cap flap or another moving, pivotable and/or movable part of a motor vehicle. With particular advantage, the present invention can be used in conjunction with doors and/or sliding doors which have an electronic control device. By way of example, such control devices may be arranged in a sliding door and designed to move together therewith.

In particular, the apparatus described here in line with the invention can be used in a motor vehicle, wherein the at least one electrical load can be mounted on a bodywork component, particularly one coated so as to be electrically insulated, of the motor vehicle. Bodywork components are considered to be doors, cargo holds, passenger compartments and the like, for example. Bodywork components coated so as to be electrically insulated mean lacquered bodywork components, in particular. If a bodywork component is electrically connected to the housing of an electrical load and this bodywork component is at ground potential, the radiated interference caused particularly by the high-frequency common-mode interference currents on the supply lines for the electrical load is significantly reduced. If the connection between the housing and the bodywork component is nonconductive, e.g. caused by the lacquering, however, or if the bodywork component is not at ground potential, for example because it is not electrically conductively connected to the ground potential of another bodywork component, the radiated interference is not reduced. By contrast, the bodywork component can then act as an antenna and amplify the radiated interference still further. This problem is safely solved in this case, which means that advantages are actually obtained for mass production in automotive construction.

The apparatus according to the invention will preferably be used in a motor vehicle, wherein an electrical load has an electric motor for operating a flap on the motor vehicle.

The invention and the technical surroundings will now be explained in more detail with reference to the figures. It should be pointed out that the variant embodiments illustrated in the figures do not limit the invention. Regularly, identical components are provided with the same reference symbols in all the figures, in which, schematically:

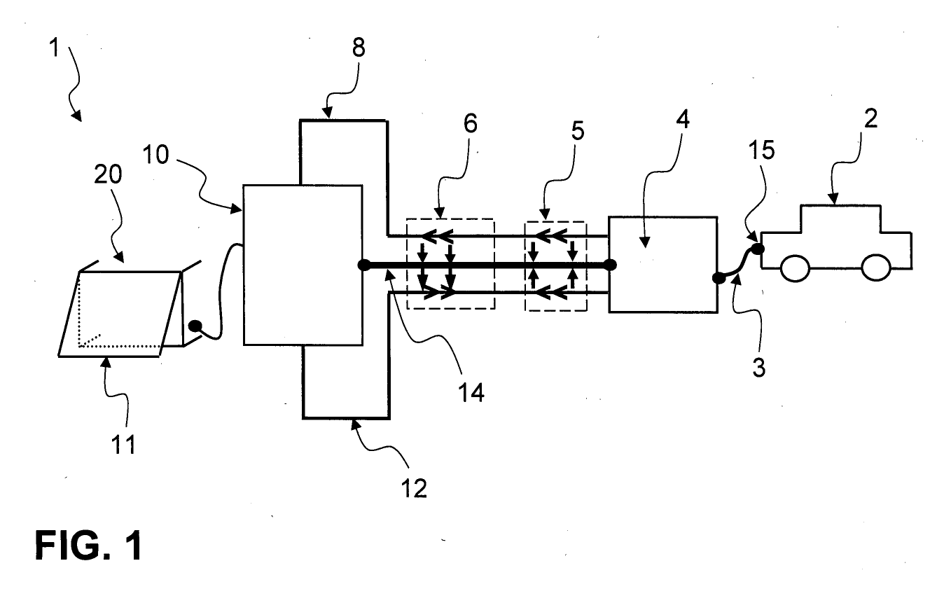

FIG. 1 shows an inventive apparatus which is connected to a motor vehicle and is used for operating a flap,

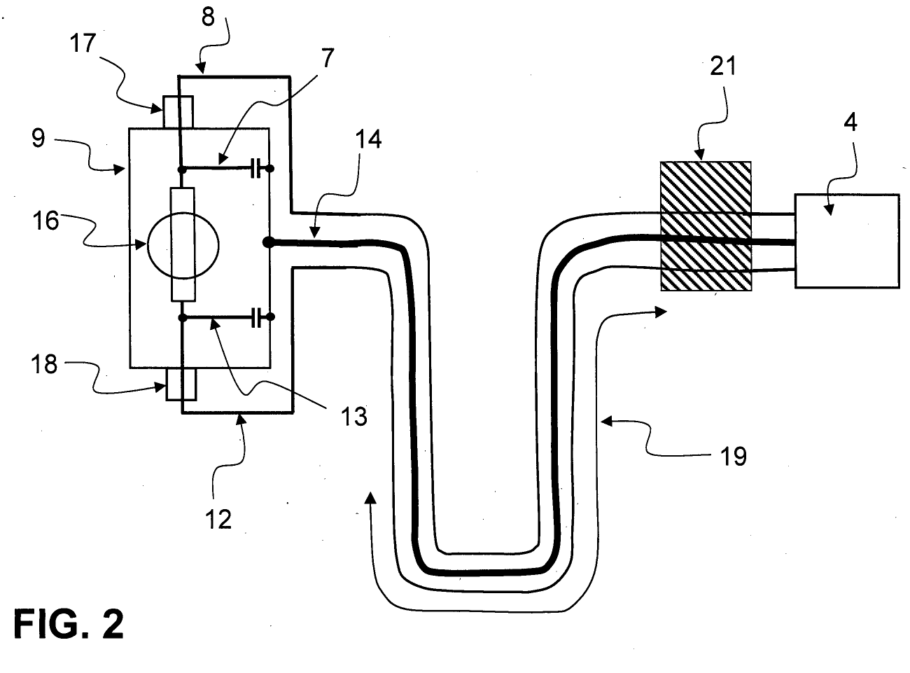

FIG. 2 shows terminals and connections between an electrical control unit and an electrical load,

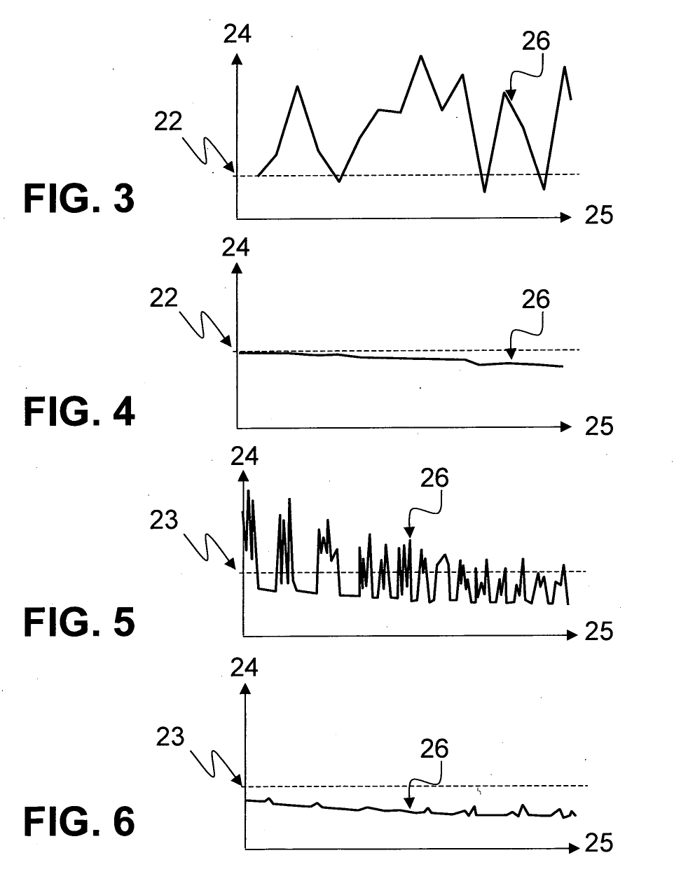

FIG. 3 shows a measured level profile for long waves in a known apparatus,

FIG. 4 shows a measured level profile for long waves in an apparatus according to the invention,

FIG. 5 shows a measured level profile for medium waves in a known apparatus, and

FIG. 6 shows a measured level profile for medium waves in an apparatus according to the invention.

FIG. 1 shows an inventive apparatus 1 which is connected to a motor vehicle 2 and is used for moving a flap 11. The electronic control unit 4 is connected to the ground potential 15 of the motor vehicle 2 by means of a second ground connection 3. The electrical load 10 is supplied by the electrical control unit 4 via the first electrical lines 8 and the second electrical line 12. The electrical load 10 is connected to the electrical control unit 4 by means of a first ground line 14. The electrical load 10 is also mounted on a bodywork component 20 and is used for removing the flap 11. The interference emitted by the electronic control unit 4 has previously caused high-frequency common-mode interference and high-frequency normal-mode interference 6 in the first electrical line 8 and the second electrical line 12. Particularly the common-mode interference has then been emitted to the environment. The apparatus shown here has been able to significantly reduce this emitted power.

FIG. 2 schematically shows possible connections and terminals on the electronic control unit 4 and the electrical load, which in this case is in the form of an electric motor 16. The first electrical line 8 and the second electrical line 12 are respectively connected to an electric motor 16 by means of a first electrical terminal 17 and a second electrical terminal 18. The electric motor 16 is located in a housing 9. The first electrical line 8 and the second electrical line 12 are notionally connected to the housing 9 by means of the first capacitive coupling 7 and the second capacitive coupling 13. The arrangement comprising the electric motor 16, the lines 8 and 12 and the housing 9 therefore has a parasitic capacitive coupling. The housing 9 is connected to the electrical control unit 4 by means of a first ground connection 14. The first ground connection 14 is central with respect to the majority of a connection path 19 and in a plane 21 between the first electrical line 8 and the second electrical line 12.

The common-mode interference 5 passes from the first electrical line 8 and the second electrical line 12 capacitively to the housing 9 of the electric motor 16. From the housing 9, the common-mode interference is routed via a ground connection 14 to the electronic control unit 4, from where it is connected to a ground potential 15. This results in significantly lower radiated interference. The spatial position of the first ground connection 14, of the first electrical line 8 and of the second electrical line 12 with respect to one another likewise prompts reduced radiated interference.

FIG. 3 and FIG. 4 schematically show the measured level profile 26 for the radiated interference from a known apparatus (FIG. 3) and an inventive apparatus (FIG. 4) in comparison. In this context, an electric motor has been examined which is used for opening or pivoting a tailgate or for opening and closing sliding doors. In this case, the long waves have been considered first of all, particularly in a range from 150 kHz to 300 kHz, the frequency range 25 shown extending right through this range, for example. A first limit 22 is also shown, which illustrates particularly the maximum tolerance of other components in the motor vehicle (e.g. 10 dbμV; 10 decibel microvolts). It can be seen that the peaks or maximum values of the level profile 26 achieve levels for the radiated interference 24 which reach twice, three times, four times or even further multiples of this first limit 22 (cf. FIG. 3). FIG. 4, by contrast, shows the level profile 26 which has been able to be achieved with an inventive modification, said level profile remaining below the first limit 22 over the entire frequency range 25 considered here.

The investigations were also performed in a corresponding manner for the medium frequency range, particularly in the frequency range 25 from 500 kHz to 1.7 MHz, measurements were performed which are compared in FIG. 5 and FIG. 6. In this case, a second limit 23 was considered, said limit being lower, in particular, than the first limit 22—e.g. 6 dBμV. The comparison between these two figures also reveals the surprisingly positive effect of the inventive apparatus, which was again tested by way of example for an electric motor for a sliding door of a motor vehicle. It was also possible to establish that the invention is particularly effective in the frequency range up to approximately 1.7 MHz, since here particularly all significant EMC maxima are rejected.

### LIST OF REFERENCE SYMBOLS

1 Apparatus
2 Motor vehicle
3 Second ground connection
4 Electronic control unit
5 Common-mode interference
6 Normal-mode interference
7 First capacitive coupling
8 First electrical line
9 Housing
10 Load
11 Flap
12 Second electrical line
13 Second capacitive coupling
14 First ground connection
15 Ground potential
16 Electric motor
17 First electrical terminal
18 Second electrical terminal
19 Connection path
20 Bodywork component
21 Plane
22 First limit
23 Second limit
24 Level of the radiated interference
25 Frequency range
26 Level profile

1. An apparatus for the operation of at least one electrical load in a motor vehicle, comprising at least
one electronic control unit which can be connected to a ground potential,
at least one electrical load,
at least one electrical line which connects the at least one load to the electronic control unit,
at least one ground connection which connects the at least one electrical load to the ground potential via the electronic control unit.

2. The apparatus as claimed in claim 1, wherein the at least one electrical load comprises at least one electric motor, wherein also the at least one electric motor preferably has a housing and at least two electrical terminals, in which a respective electrical line is connected to an electrical terminal and the, particularly one, ground connection is connected to the housing.

3. The apparatus as claimed in claim 1, wherein the at least one electrical line and the at least one ground connection determine a connection path and are in contact with one another for the majority of the connection path, the majority preferably being at least 70% or even at least 90% of the connection path.

4. The apparatus as claimed in claim 1, wherein the at least one electrical line is not entwined with the at least one ground connection.

5. The apparatus as claimed in claim 1, wherein a plurality of electrical lines are provided, wherein a ground connection is positioned centrally with respect to the plurality of electrical lines.

6. The apparatus as claimed in claim 5, wherein two electrical lines are arranged in one plane, and a single ground connection is positioned in between.

7. The use of the apparatus as claimed in claim 1 for moving a flap on a motor vehicle.

8. A motor vehicle having the apparatus as claimed in claim 1, wherein the at least one electrical load is mounted on a bodywork element, particularly one coated so as to be electrically insulated, of the motor vehicle.

9. The motor vehicle as claimed in claim 8, wherein an electrical load has an electric motor for operating a flap on the motor vehicle.
